(19) United States
(12) Patent Application Publication
(10) Pub. No.: US 2025/0055655 A1
(43) Pub. Date: Feb. 13, 2025

(54) SIGNALING ASSOCIATED WITH BEAM ACTIVATION AND DEACTIVATION

(71) Applicant: QUALCOMM Incorporated, San Diego, CA (US)

(72) Inventors: Shankar KRISHNAN, Poway, CA (US); Navid ABEDINI, Basking Ridge, NJ (US); Naeem AKL, Bridgewater, NJ (US)

(21) Appl. No.: 18/772,842

(22) Filed: Jul. 15, 2024

Related U.S. Application Data
(60) Provisional application No. 63/519,128, filed on Aug. 11, 2023.

(51) Int. Cl. H04L 5/00; H04B 7/06

(52) U.S. Cl. CPC H04L 5/0098; H04B 7/0617

(57) ABSTRACT

Various aspects of the present disclosure generally relate to wireless communication. In some aspects, a user equipment (UE) may receive first system information indicative of a first synchronization signal block (SSB) configuration, the first SSB configuration indicating a plurality of SSBs comprising at least one deactivated SSB. The UE may receive, based on a reactivation of the at least one deactivated SSB, second system information, the second system information omitting a second SSB configuration. Numerous other aspects are described.

### CROSS-REFERENCE TO RELATED APPLICATION

This patent application claims priority to U.S. Provisional Patent Application No. 63/519,128, filed on Aug. 11, 2023, entitled “SIGNALING ASSOCIATED WITH BEAM ACTIVATION AND DEACTIVATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for signaling associated with beam activation and deactivation.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured, individually or in any combination, to cause the UE to receive first system information indicative of a first synchronization signal block (SSB) configuration, the first SSB configuration indicating a plurality of SSBs comprising at least one deactivated SSB. The one or more processors may be configured, individually or in any combination, to cause the UE to receive, based on a reactivation of the at least one deactivated SSB, second system information, the second system information omitting a second SSB configuration.

Some aspects described herein relate to a network node for wireless communication. The network node may include one or more memories and one or more processors coupled to the one or more memories. The one or more processors may be configured, individually or in any combination, to cause the network node to transmit first system information indicative of a first SSB configuration, the first SSB configuration indicating a plurality of SSBs comprising at least one deactivated SSB. The one or more processors may be configured, individually or in any combination, to cause the network node to transmit, based on a reactivation of the at least one deactivated SSB, second system information, the second system information omitting a second SSB configuration.

Some aspects described herein relate to a UE for wireless communication. The UE may include one or more memories and one or more processors coupled to the one or more memories. The one or more processors may be configured, individually or in any combination, to cause the UE to receive first system information comprising first SSB coverage information associated with a first physical beam mapping. The one or more processors may be configured, individually or in any combination, to cause the UE to receive, based on at least one of a reactivation of at least one deactivated SSB or a deactivation of at least one activated SSB, second system information comprising second SSB coverage information associated with a second physical beam mapping.

Some aspects described herein relate to a network node for wireless communication. The network node may include one or more memories and one or more processors coupled to the one or more memories. The one or more processors may be configured, individually or in any combination, to cause the network node to receive first SSB coverage information associated with a first physical beam mapping. The one or more processors may be configured, individually or in any combination, to cause the network node to receive, based on at least one of a reactivation of at least one deactivated SSB or a deactivation of at least one activated SSB, second SSB coverage information associated with a second physical beam mapping.

Some aspects described herein relate to a network node for wireless communication. The network node may include one or more memories and one or more processors coupled to the one or more memories. The one or more processors may be configured, individually or in any combination, to cause the network node to transmit first SSB coverage information associated with a first physical beam mapping. The one or more processors may be configured, individually or in any combination, to transmit, based on at least one of a reactivation of at least one deactivated SSB or a deactivation of at least one activated SSB, second SSB coverage information associated with a second physical beam mapping.

Some aspects described herein relate to a method of wireless communication performed by a UE. The method may include receiving first system information indicative of a first SSB configuration, the first SSB configuration indicating a plurality of SSBs comprising at least one deactivated SSB. The method may include receiving, based on a reactivation of the at least one deactivated SSB, second system information, the second system information omitting a second SSB configuration.

Some aspects described herein relate to a method of wireless communication performed by a network node. The method may include transmitting first system information indicative of a first SSB configuration, the first SSB configuration indicating a plurality of SSBs comprising at least one deactivated SSB. The method may include transmitting, based on a reactivation of the at least one deactivated SSB, second system information, the second system information omitting a second SSB configuration.

Some aspects described herein relate to a method of wireless communication performed by a UE. The method may include receiving first system information comprising first SSB coverage information associated with a first physical beam mapping. The method may include receiving, based on at least one of a reactivation of at least one deactivated SSB or a deactivation of at least one activated SSB, second system information comprising second SSB coverage information associated with a second physical beam mapping.

Some aspects described herein relate to a method of wireless communication performed by a network node. The method may include receiving first SSB coverage information associated with a first physical beam mapping. The method may include receiving, based on at least one of a reactivation of at least one deactivated SSB or a deactivation of at least one activated SSB, second SSB coverage information associated with a second physical beam mapping.

Some aspects described herein relate to a method of wireless communication performed by a network node. The method may include transmitting first SSB coverage information associated with a first physical beam mapping. The method may include transmitting, based on at least one of a reactivation of at least one deactivated SSB or a deactivation of at least one activated SSB, second SSB coverage information associated with a second physical beam mapping.

Some aspects described herein relate to a non-transitory computer-readable medium that stores a set of instructions for wireless communication by a UE. The set of instructions, when executed by one or more processors of the UE, may cause the UE to receive first system information indicative of a first SSB configuration, the first SSB configuration indicating a plurality of SSBs comprising at least one deactivated SSB. The set of instructions, when executed by one or more processors of the UE, may cause the UE to receive, based on a reactivation of the at least one deactivated SSB, second system information, the second system information omitting a second SSB configuration.

Some aspects described herein relate to a non-transitory computer-readable medium that stores a set of instructions for wireless communication by a network node. The set of instructions, when executed by one or more processors of the network node, may cause the network node to transmit first system information indicative of a first SSB configuration, the first SSB configuration indicating a plurality of SSBs comprising at least one deactivated SSB. The set of instructions, when executed by one or more processors of the network node, may cause the network node to transmit, based on a reactivation of the at least one deactivated SSB, second system information, the second system information omitting a second SSB configuration.

Some aspects described herein relate to a non-transitory computer-readable medium that stores a set of instructions for wireless communication by a UE. The set of instructions, when executed by one or more processors of the UE, may cause the UE to receive first system information comprising first SSB coverage information associated with a first physical beam mapping. The set of instructions, when executed by one or more processors of the UE, may cause the UE to receive, based on at least one of a reactivation of at least one deactivated SSB or a deactivation of at least one activated SSB, second system information comprising second SSB coverage information associated with a second physical beam mapping.

Some aspects described herein relate to a non-transitory computer-readable medium that stores a set of instructions for wireless communication by a network node. The set of instructions, when executed by one or more processors of the network node, may cause the network node to receive first SSB coverage information associated with a first physical beam mapping. The set of instructions, when executed by one or more processors of the network node, may cause the network node to receive, based on at least one of a reactivation of at least one deactivated SSB or a deactivation of at least one activated SSB, second SSB coverage information associated with a second physical beam mapping.

Some aspects described herein relate to a non-transitory computer-readable medium that stores a set of instructions for wireless communication by a network node. The set of instructions, when executed by one or more processors of the network node, may cause the network node to transmit first SSB coverage information associated with a first physical beam mapping. The set of instructions, when executed by one or more processors of the network node, may cause the network node to transmit, based on at least one of a reactivation of at least one deactivated SSB or a deactivation of at least one activated SSB, second SSB coverage information associated with a second physical beam mapping.

Some aspects described herein relate to an apparatus for wireless communication. The apparatus may include means for receiving first system information indicative of a first SSB configuration, the first SSB configuration indicating a plurality of SSBs comprising at least one deactivated SSB. The apparatus may include means for receiving, based on a reactivation of the at least one deactivated SSB, second system information, the second system information omitting a second SSB configuration.

Some aspects described herein relate to an apparatus for wireless communication. The apparatus may include means for transmitting first system information indicative of a first SSB configuration, the first SSB configuration indicating a plurality of SSBs comprising at least one deactivated SSB. The apparatus may include means for transmitting, based on a reactivation of the at least one deactivated SSB, second system information, the second system information omitting a second SSB configuration.

Some aspects described herein relate to an apparatus for wireless communication. The apparatus may include means for receiving first SSB coverage information associated with a first physical beam mapping. The apparatus may include means for receiving, based on at least one of a reactivation of at least one deactivated SSB or a deactivation of at least one activated SSB, second SSB coverage information associated with a second physical beam mapping.

Some aspects described herein relate to an apparatus for wireless communication. The apparatus may include means for transmitting first SSB coverage information associated with a first physical beam mapping. The apparatus may include means for transmitting, based on at least one of a reactivation of at least one deactivated SSB or a deactivation of at least one activated SSB, second SSB coverage information associated with a second physical beam mapping.

Aspects generally include a method, apparatus, system, computer program product, non-transitory computer-readable medium, user equipment, base station, network entity, network node, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a synchronization signal (SS) hierarchy, in accordance with the present disclosure.

FIG. 5 is a diagram illustrating an example associated with signaling associated with beam activation and deactivation, in accordance with the present disclosure.

FIG. 6 is a diagram illustrating an example process performed, for example, at a UE or an apparatus of a UE, in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

FIG. 12 is a diagram illustrating an example of signaling of synchronization signal block coverage information associated with physical beam mappings, in accordance with the present disclosure.

### DETAILED DESCRIPTION

Inter-node beam activation is a technique that can be supported as part of a network energy savings initiative. In some cases, inter-node beam activation allows a network node to request a neighboring network node to reactivate certain synchronization signal block (SSB) beams which have been deactivated before, without the need to reactivate the entire cell, thereby saving network energy. In some cases, each time one or more SSBs is deactivated and/or reactivated, system information may be updated by including an updated SSB configuration bitmap. As the frequency of inter-node beam activation increases, the resulting increased overhead associated with updating the system information can result in a decrease in efficient use of radio resources and/or an increase in power consumption at the network node and a user equipment (UE). Additionally, in some cases, frequent updating of an SSB configuration bitmap may result in loss of SSB context.

Some aspects of the techniques described herein may provide signaling associated with beam activation and deactivation that reduces a frequency of updating system information provided to a UE. In some aspects, for example, a UE may receive first system information indicative of a first SSB configuration. The first SSB configuration may be a first SSB configuration bitmap indicating a plurality of SSBs, at least one of which is activated and at least one of which is deactivated. At least one SSB may be deactivated but second system information received by the UE may not include a second SSB configuration (e.g., bitmap). In some aspects, the second system information may indicate an updated SSB coverage state and/or an updated SSB activated list. In some aspects, the first SSB configuration may be a reference SSB configuration and the second system information may indicate a difference between the first SSB configuration and the second SSB configuration. In this way, the network node may avoid sending a new SSB configuration each time an SSB is activated or deactivated, thereby reducing signaling overhead and resulting in improved efficiency associated with resource use and/or energy consumption at the network node and/or the UE.

In some cases, deactivation of SSBs associated with a cell can lead to decreased energy efficiency in association with sweeping operations. For example, if a cell can transmit SSBs in ten directions (D1, . . . , D10), a network node that provides the cell may assign SSB indexes so that SSBi is transmitted in direction Di. Thus, the network node may sweep, during an SSB burst, the ten directions by sweeping through SSB1, . . . , SSB10, where each SSBi is transmitted during a corresponding SSB occasion. If the network node deactivates SSB transmissions in directions D4, . . . , D8, a time gap corresponding to the SSB occasions associated with D4, . . . , D8 would occur during sweeping, thereby resulting in reduced efficiency at the network and/or the UE.

Some aspects of the techniques described herein may include rearranging the SSB indexes corresponding to the active SSBs to form a more compact SSB burst composition. For example, the network node may rearrange SSB1, SSB2, and SSB3, so that SSB1, . . . , SSB3 are mapped to D1, . . . , D3, respectively and may rearrange SSB4 and SSB5 so that SSB4 and SSB5 are mapped to D9 and D10, respectively. In some aspects, signaling on the access link interface (Uu interface), the Xn interface, and/or the F1 interface may be specified to refer to physical beam direction (instead of reference signal indexes such as SSB indexes). In some aspects, the Xn interface and/or the F1 interface may be configured to support signaling in which the SSB coverage state can be exchanged without linking the SSB coverage state to SSB indexes. For example, the SSB coverage state can be extended to refer to the beamforming codebook elements used for SSB transmission, where each element is associated with a physical beam direction and a beam-shape. In this way, the network node may avoid sending a new SSB configuration each time an SSB is activated or deactivated and may reduce time gaps between SSB transmissions in an SSB burst, thereby reducing signaling overhead and resulting in improved efficiency associated with resource use and/or energy consumption at the network node and/or the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

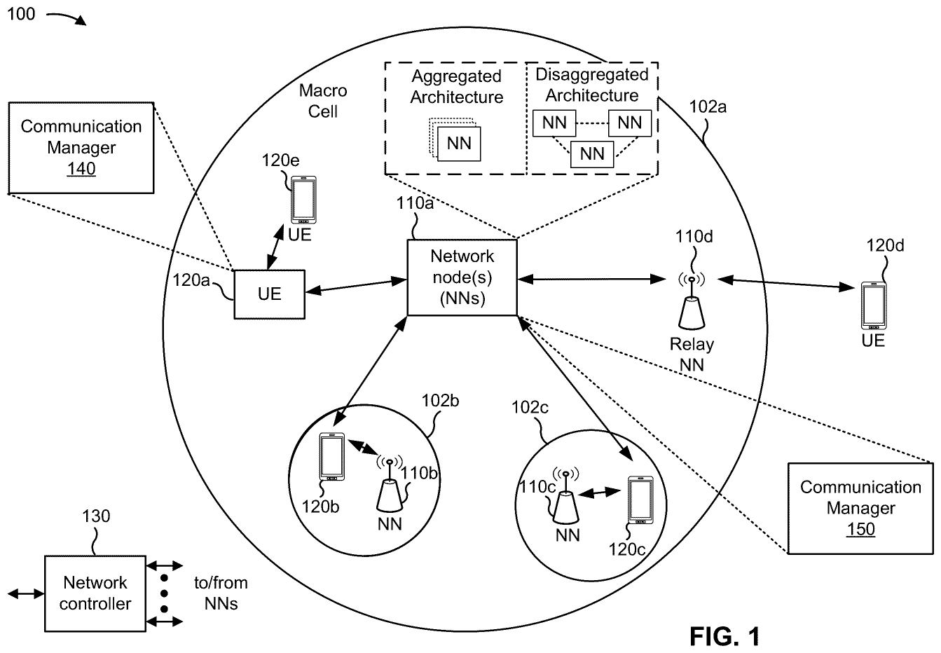

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FRI, FR2, FR3, FR4, FR4-a, FR4-1, and/or FR5) may be modified, and techniques described herein are applicable to those modified frequency ranges.

In some aspects, a UE (e.g., the UE 120) may include a communication manager 140. As described in more detail elsewhere herein, the communication manager 140 may receive first system information indicative of a first SSB configuration, the first SSB configuration indicating a plurality of SSBs comprising at least one deactivated SSB; and receive, based on a reactivation of the at least one deactivated SSB, second system information, the second system information omitting a second SSB configuration. In some aspects, the communication manager 140 may receive first system information comprising first SSB coverage information associated with a first physical beam mapping; and receive, based on at least one of a reactivation of at least one deactivated SSB or a deactivation of at least one activated SSB, second system information comprising second SSB coverage information associated with a second physical beam mapping. Additionally, or alternatively, the communication manager 140 may perform one or more other operations described herein.

In some aspects, a network node (e.g., the network node 110) may include a communication manager 150. As described in more detail elsewhere herein, the communication manager 150 may transmit first system information indicative of a first SSB configuration, the first SSB configuration indicating a plurality of SSBs comprising at least one deactivated SSB; and transmit, based on a reactivation of the at least one deactivated SSB, second system information, the second system information omitting a second SSB configuration. In some aspects, the communication manager 150 may transmit first system information comprising first SSB coverage information associated with a first physical beam mapping; and transmit, based on at least one of a reactivation of at least one deactivated SSB or a deactivation of at least one activated SSB, second system information comprising second SSB coverage information associated with a second physical beam mapping. Additionally, or alternatively, the communication manager 150 may perform one or more other operations described herein.

As indicated above, FIG. 1 is provided as an example. Other examples may differ from what is described with regard to FIG. 1.

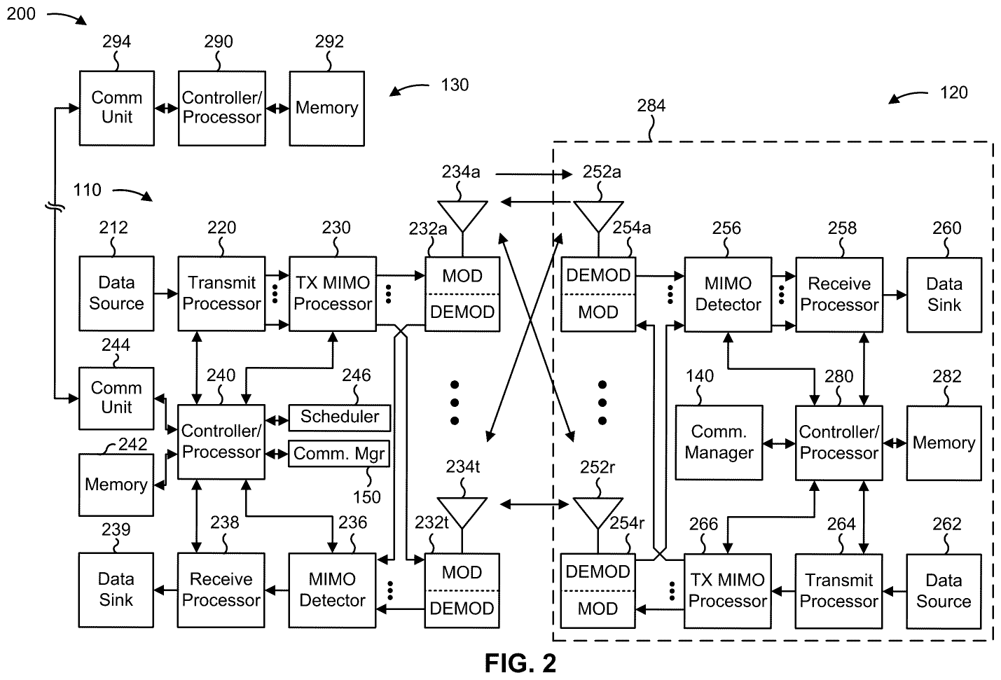

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

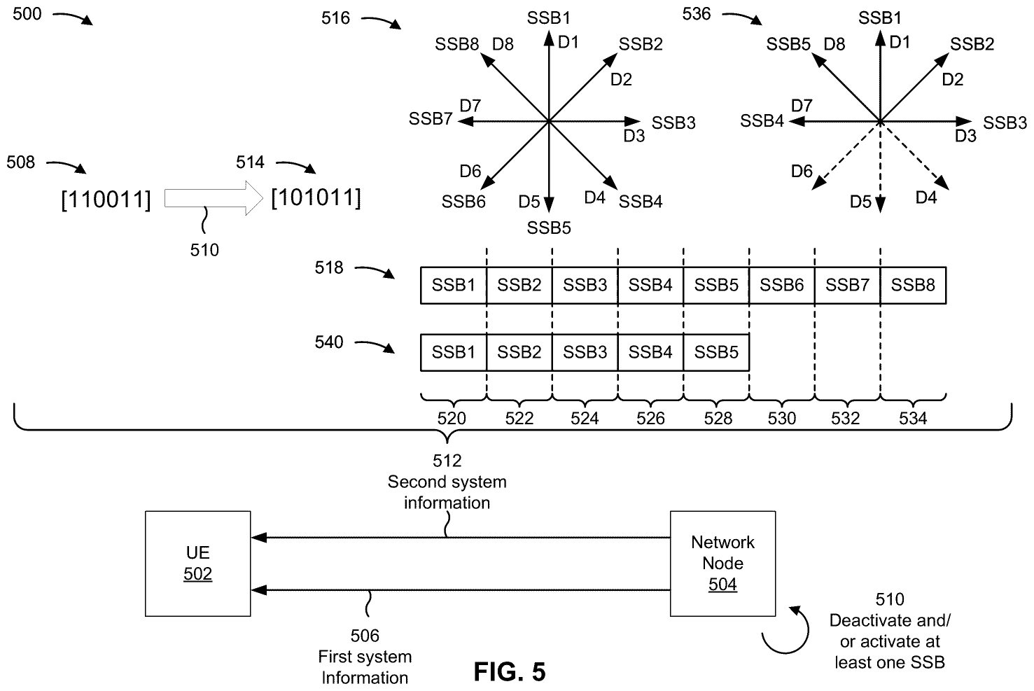

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

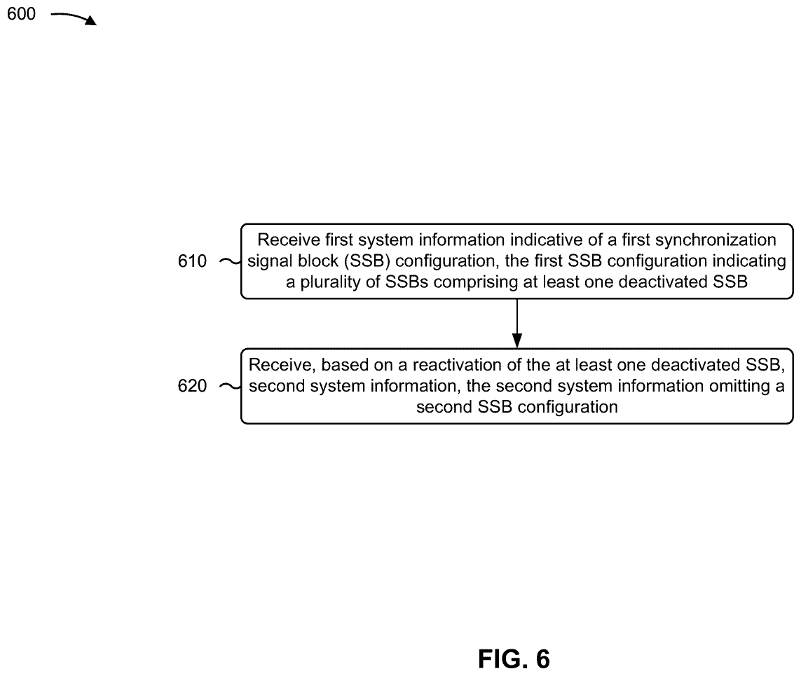

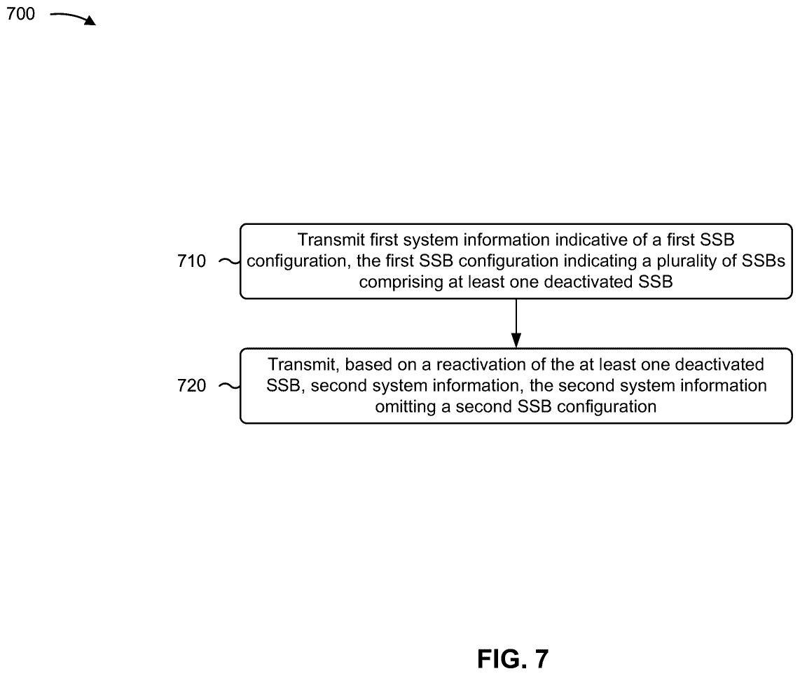

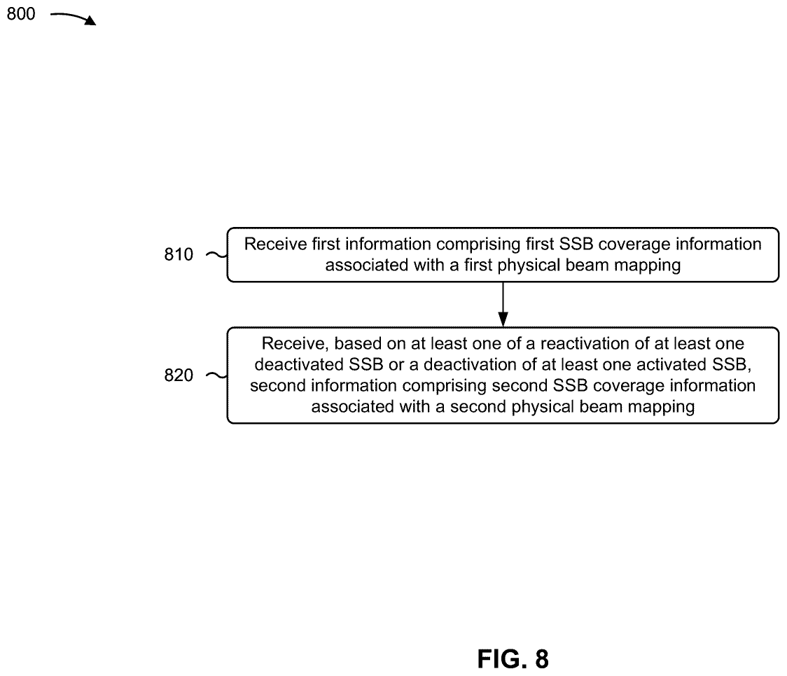

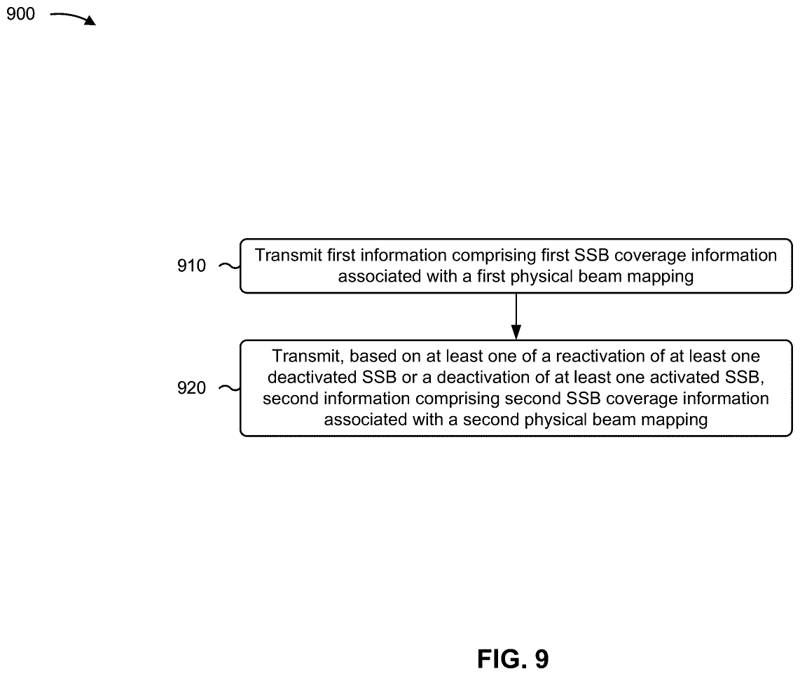

The controller/processor 240 of the network node 110, the controller/processor 280 of the UE 120, and/or any other component(s) of FIG. 2 may perform one or more techniques associated with signaling associated with beam activation and deactivation, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving first system information indicative of a first synchronization signal block (SSB) configuration, the first SSB configuration indicating a plurality of SSBs comprising at least one deactivated SSB; and/or means for receiving, based on a reactivation of the at least one deactivated SSB, second system information, the second system information omitting a second SSB configuration. In some aspects, the UE includes means for receiving first system information comprising first SSB coverage information associated with a first physical beam mapping; and/or means for receiving, based on at least one of a reactivation of at least one deactivated SSB or a deactivation of at least one activated SSB, second system information comprising second SSB coverage information associated with a second physical beam mapping. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting first system information indicative of a first SSB configuration, the first SSB configuration indicating a plurality of SSBs comprising at least one deactivated SSB; and/or means for transmitting, based on a reactivation of the at least one deactivated SSB, second system information, the second system information omitting a second SSB configuration. In some aspects, the network node includes means for transmitting first system information comprising first SSB coverage information associated with a first physical beam mapping; and/or means for transmitting, based on at least one of a reactivation of at least one deactivated SSB or a deactivation of at least one activated SSB, second system information comprising second SSB coverage information associated with a second physical beam mapping. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

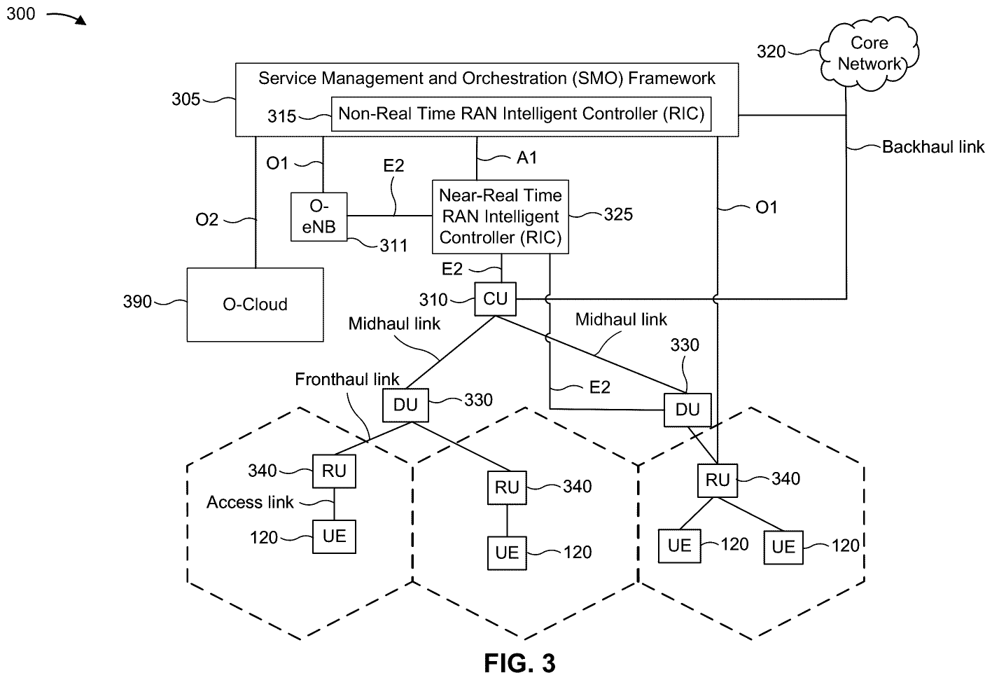

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Inter-node beam activation is a technique that can be supported as part of a network energy savings initiative. In some cases, inter-node beam activation allows a RAN node to request a neighboring RAN node to reactivate certain SSB beams which have been deactivated before, without the need to reactivate the entire cell, thereby saving network energy.

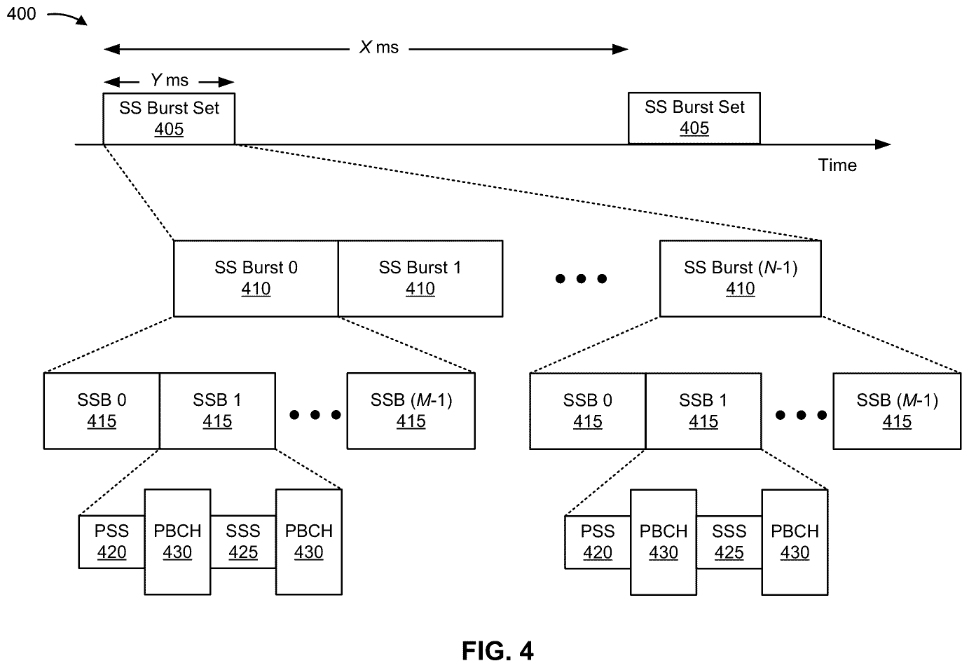

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SS blocks (SSBs) 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a PSS 420, an SSS 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., an RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

The SSB occasions in which the base station is to transmit an SSB in an SSB transmission period may be indicated by a bitmap in an information element (e.g., ssb-PositionsInBurst). The network node may transmit the information element to other network nodes and/or UEs as part of system information (e.g., SIB 1) or radio resource control (RRC) signaling. Additionally, or alternatively, as described elsewhere herein, the network node may transmit the information element to other network nodes as part of backhaul signaling, such as an F1 setup request, an Xn setup request/response, a DU configuration update, an NG-RAN node configuration update, a cell activation request, or a CU configuration update. Each bit in the bitmap may correspond to an SSB occasion, and the value of a particular bit in the bitmap may indicate whether an SSB is to be transmitted in the associated SSB occasion. As an example, a bitmap of 0101 may indicate that an SSB is to be transmitted in the SSB occasions associated with SSB index 2 and SSB index 4.

In some aspects, the network node may transmit each SSB in an SSB transmission period on the same transmit beam, or may transmit one or more SSBs in an SSB transmission period on a different transmit beam for purposes of spatial diversity. A UE may measure the SSB transmissions to identify a beam with the highest signal strength and may initiate a random access channel (RACH) procedure using the identified beam to establish a connection with the network node.

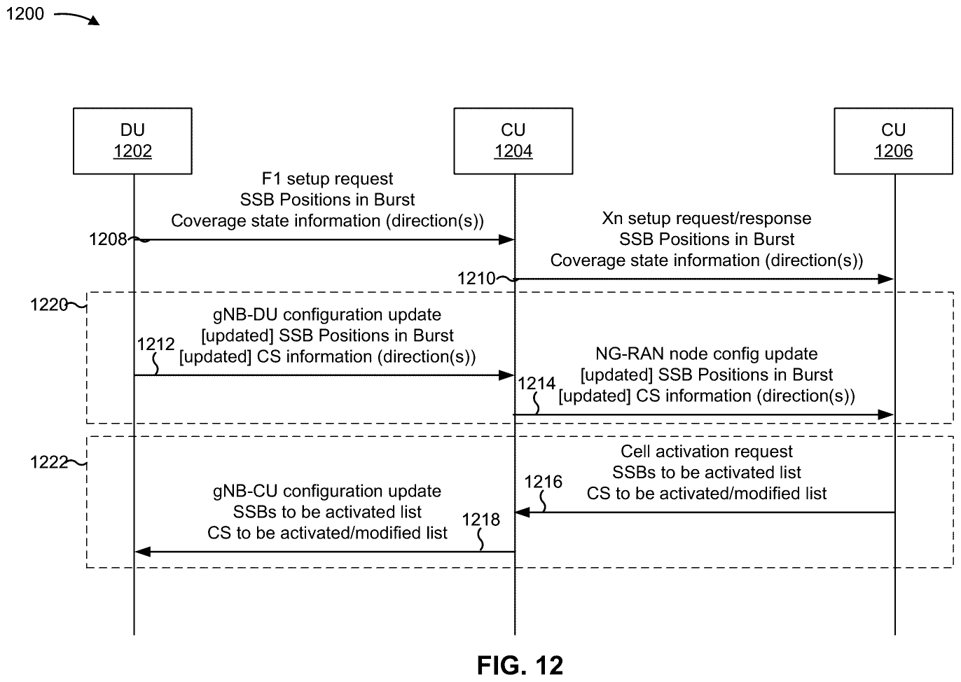

In some cases, a network node may reuse a CELL ACTIVATION procedure over Xn application protocol (XnAP) and the CU CONFIGURATION UPDATE procedure over F1 application protocol (F1AP) for inter-node beam activation. In the case of using XnAP for inter-node beam activation, if the NR Cells and SSBs List IE is included in the CELL ACTIVATION REQUEST message sent from a first RAN node to a second RAN node, the second RAN node can, if supported, only activate the SSB beams indicated by the SSBs to be Activated List IE if included. In some cases, if the SSBs to be Activated List IE associated with the cell indicated by the NG cell global identity (CGI) information element (IE) is not included, the second RAN node can, if supported, activate all of the inactive SSB beams in the cell. In some cases, if at least one requested SSB beam in the SSBs to be Activated List IE is activated, the second RAN node can include the SSBs Activated List IE in the CELL ACTIVATION RESPONSE message. The first RAN node can consider the SSB beams indicated by the SSBs Activated List IE as activated. If the second RAN node cannot activate any of the cells or any of the SSB beams indicated in the CELL ACTIVATION REQUEST message, the second RAN node can respond with the CELL ACTIVATION FAILURE message with an appropriate cause value. In some examples described herein, one or more of these messages may include an indication of a physical beam mapping as described with regard to FIG. 12.

In the case of using F1AP for inter-node beam activation, if SSBs within the “Cell to be Activated List” IE are included in the Cells to be Activated List Item IE within the gNB-CU CONFIGURATION UPDATE message, the DU can, if supported, only activate the SSB beams indicated by SSB within the “Cell to be Activated List IE”. If at least one requested SSB beam in the SSBs within the “Cell to be Activated List IE” is activated, the DU can include the Cells with SSBs Activated List IE in the CU CONFIGURATION UPDATE ACKNOWLEDGE message. The CU can consider the SSB beams indicated by the SSBs Activated List IE as activated. In case the DU cannot activate any of the requested SSB beams, it can respond with the CU CONFIGURATION UPDATE FAILURE message with an appropriate cause value. In some examples described herein, one or more of these messages may include information relating to a physical beam mapping as described with regard to FIG. 12.

In some cases, an NR Coverage and Capacity Optimization (CCO) function can be used to detect and resolve or mitigate CCO issues (e.g., coverage and cell edge interference issues). In some cases, each RAN node may be configured with alternative coverage configurations by an operations and management (OAM) network function. The alternative coverage configurations may contain relevant radio parameters and may also include a range for how each parameter is allowed to be adjusted. In some cases, a RAN node may autonomously adjust within and switch between coverage configurations. When a change is executed, a RAN node may notify its neighbor RAN nodes using the NG-RAN NODE CONFIGURATION UPDATE message with the list of cells and SSBs with modified coverage included. The list can contain the CGI of each modified cell with its coverage state indicator and optionally the SSB index of each modified SSB with its coverage state indicator (“SSB coverage state”). The coverage state indicator may be used at the receiving RAN node to adjust the functions of the Mobility Robustness Optimization (e.g., by using the coverage state indicator to retrieve a previously stored Mobility Robustness Optimization state). The coverage state indicator may also be used at the receiving RAN node to adopt coverage configurations matching with neighboring cells coverage configurations. In some aspects one or more of these messages may include information relating to a physical beam mapping as described with regard to FIG. 12.

CCO can be implemented in an aggregated base station architecture such as the aggregated base station architecture 300 depicted in FIG. 3. For example, a CCO detection function can be located at the CU. The CU can signal to the DU the CCO issue and the affected cells and beams. The DU can resolve the CCO issue concerning its own served cell by local action within the OAM configured limits. The DU may also take into account information received for other cells when adopting the CCO configuration. In some cases, the DU can inform the CU of the new coverage states adopted. In some cases, the DU can make the final decision to (re) activate SSB beams (activation is decided by the DU either autonomously or upon the CU's request) and can inform the CU about the beams that are currently switched ON via one or more of several options. In a first option (Option 1), the DU can indicate, via system information (e.g., a system information block 1 (SIB1)), SSB positions in a burst using an SSB configuration. The SSB configuration may be indicated using a bitmap, as described above. In a second option (Option 2), the DU may indicate the reactivated beams via an SSB coverage state. In a third option (Option 3), the DU may indicate the reactivated beams via an SSB Activated list (e.g., when the CU requests activation).

In some cases, each time one or more SSBs is deactivated and/or reactivated, a SIB1 may be updated by including an updated SSB configuration bitmap. As the frequency of inter-node beam activation increases, the resulting increased overhead associated with updating the SIB1 can result in a decrease in efficient use of radio resources and/or an increase in power consumption at the network node and the UE. Additionally, in some cases, frequent updating of an SSB configuration bitmap may result in loss of SSB context.

Some aspects of the techniques described herein may provide signaling associated with beam activation and deactivation that reduces a frequency of updating system information provided to a UE. For example, a UE's ability to access a network may not be impacted if the UE assumes that one or more SSBs are active even when they're not and/or if the UE assumes that one or more SSBS are deactivated even when they're not. In some aspects, for example, a UE may receive first system information (e.g., a first SIB1) indicative of a first SSB configuration. The first SSB configuration may be a first SSB configuration bitmap indicating a plurality of SSBs, at least one of which is activated and at least one of which is deactivated. At least one SSB may be deactivated but second system information received by the UE may not include a second SSB configuration (e.g., bitmap). In some aspects, the second system information may indicate an updated SSB coverage state and/or an updated SSB activated list. In some aspects, the first SSB configuration may be a reference SSB configuration and the second system information may indicate a difference between the first SSB configuration and the second SSB configuration. In this way, the network node may avoid sending a new SSB configuration each time an SSB is activated or deactivated, thereby reducing signaling overhead and resulting in improved efficiency associated with resource use and/or energy consumption at the network node and/or the UE.

In some cases, deactivation of SSBs associated with a cell can lead to decreased energy efficiency in association with sweeping operations. For example, if a cell can transmit SSBs in ten directions (D1, . . . , D10), a network node that provides the cell may assign SSB indexes so that SSBi is transmitted in direction Di. Thus, the network node may sweep, during an SSB burst, the ten directions by sweeping through SSB1, . . . , SSB10, where each SSBi is transmitted during a corresponding SSB occasion. If the network node deactivates SSB transmissions in directions D4, . . . , D8, a time gap corresponding to the SSB occasions associated with D4, . . . , D8 would occur during sweeping, thereby resulting in reduced efficiency at the network and/or the UE.

Some aspects of the techniques described herein may include rearranging the SSB indexes corresponding to the active SSBs to form a more compact SSB burst composition. For example, the network node may rearrange SSB1, SSB2, and SSB3, so that SSB1, . . . , SSB3 are mapped to D1, . . . , D3, respectively and may rearrange SSB4 and SSB5 so that SSB4 and SSB5 are mapped to D9 and D10, respectively. In some aspects, signaling on the access link interface (Uu interface), the Xn interface, and/or the F1 interface may be specified to refer to physical beam direction (instead of SSB indexes). In some aspects, the Xn interface and/or the F1 interface may be configured to support signaling in which the SSB coverage state can be exchanged without linking the SSB coverage state to SSB indexes. In some aspects, the SSB coverage state can be extended to refer to the beamforming codebook elements used for SSB transmission where each element is associated with a physical beam direction and a beam-shape. The mapping can be internal to the DU/CU or as specified by OAM. In some aspects, for increased granularity, the range of SSB coverage states may be increased (e.g., from a value of 16 to 16*64) for covering different physical beam directions and/or a new IE for capturing the physical beam direction (e.g., beam tilt and/or azimuth) may be defined. In this way, the network node may avoid sending a new SSB configuration each time an SSB is activated or deactivated and may reduce time gaps between SSB transmissions in an SSB burst, thereby reducing signaling overhead and resulting in improved efficiency associated with resource use and/or energy consumption at the network node and/or the UE.

As indicated above, FIG. 4 is provided as an example. Other examples may differ from what is described with regard to FIG. 4.

FIG. 5 is a diagram illustrating an example 500 associated with signaling associated with beam activation and deactivation, in accordance with the present disclosure. As shown, a UE 502 and a network node 504 may communicate with one another. The UE 502 and the network node 504 may communicate with one another via a wireless network (e.g., the wireless network 100 depicted in FIG. 1). The UE 502 may be, be similar to, include, or be included in the UE 120 depicted in FIGS. 1-3. The network node 504 may be, be similar to, include, or be included in, the network node 110 depicted in FIGS. 1 and 2, and/or one or more components of the disaggregated base station architecture 300 depicted in FIG. 3. In some aspects, the network node 504 may provide one or more cells and may represent more than one network node. The network node 504 may provide a cell.

As shown by reference number 506, the network node 504 may transmit, and the UE 502 may receive, first system information. The first system information may be, for example, a first SIB1. The first system information may be indicative of a first SSB configuration 508. The first SSB configuration 508 may indicate a plurality of SSBs including at least one activated SSB and/or at least one deactivated SSB. For example, the first SSB configuration may include a bitmap that indicates the activation status of each SSB associated with the cell. For example, a “0” may indicated a deactivated SSB and a “1” may indicate an activated SSB. Thus, for example, the SSB configuration 508 in example 500 may indicate that SSB1, SSB2, SSB5, and SSB6 are activated and that SSB3 and SSB4 are deactivated. In some aspects, the first SSB configuration may indicate a quantity of supported SSBs and a plurality of indexes. Each index of the plurality of indexes may correspond to a respective SSB of the plurality of SSBs. The plurality of SSBs may be mapped to a plurality of respective beams.

As shown by reference number 510, the network node 504 may deactivate and/or activate (or reactivate) at least one SSB. As shown by reference number 512, the network node 504 may transmit, and the UE 502 may receive, second system information. In some aspects, for example, the second system information may be transmitted based on a reactivation of at least one deactivated SSB. The second system information may omit a second SSB configuration 514 (e.g., an updated bitmap). In some aspects, instead of providing a second SSB configuration 514, the second system information may indicate at least one of an updated SSB coverage state or an updated SSB activated list. In some aspects, the second system information indicates a difference between the first SSB configuration 508 and the second SSB configuration 514. For example, the second system information may indicate that SSB2 is deactivated and SSB3 is reactivated, without indicating the entire second SSB configuration 514.

In some aspects, the first system information may include first SSB coverage information and the second system information may include second SSB coverage information. The first SSB coverage information may be associated with a first physical beam mapping and the second SSB coverage information may be associated with a second physical beam mapping. The first physical beam mapping may map a first physical beam direction to a first SSB index and the second physical beam mapping may map a second physical beam direction to the first SSB index. For example, as shown by the illustrative representation of a first physical beam mapping 516, the first physical beam mapping 516 may map SSB1 to a first direction D1, SSB2 to a second direction D2, SSB3 to a second direction D3, SSB4 to a second direction D4, SSB5 to a second direction D5, SSB6 to a second direction D6, SSB7 to a second direction D7, and SSB8 to a second direction D8.

The network node 504 may rearrange the SSB index mappings to facilitate reduction of time gaps in a resulting burst. For example, in accordance with the first physical beam mapping 516, an SSB burst 518 may be configured such that SSB1 is transmitted in a first SSB occasion 520, SSB2 is transmitted in a second SSB occasion 522, SSB3 is transmitted in a third SSB occasion 524, SSB4 is transmitted in a fourth SSB occasion 526, SSB5 is transmitted in a fifth SSB occasion 528, SSB6 is transmitted in a sixth SSB occasion 530, SSB7 is transmitted in a seventh SSB occasion 532, and SSB8 is transmitted in an eighth SSB occasion 534. If the network node 504 deactivates, for example, the beam directions D4, D5, and D6, and the SSB burst 518 is transmitted with the configuration shown, there would be no transmission during the SSB occasions 526, 528, and 530, thus causing a time gap between the transmission of SSB3 and the transmission of SSB7. The network node 504 may rearrange the physical beam mappings to create a second physical beam mapping 536, in which SSB1-SSB3 are mapped to D1-D3, respectively, and SSB4 and SSB5 are mapped to direction D7 and D8, respectively. In this way, the network node 504 may transmit an SSB burst 540, in which there is no time gap between any adjacent pair of swept SSBs.

In some aspects, the first SSB coverage information may indicate a first beam direction and the second SSB coverage information may indicate a second beam direction. In some aspects, the first SSB coverage information may indicate a first beamforming codebook element and the second SSB coverage information may indicate a second beamforming codebook element. For example, at least one of the first beamforming codebook element or the second beamforming codebook element may indicate a physical beam direction and a beam shape.

As indicated above, FIG. 5 is provided as an example. Other examples may differ from what is described with regard to FIG. 5.

FIG. 6 is a diagram illustrating an example process 600 performed, for example, at a UE or an apparatus of a UE, in accordance with the present disclosure. Example process 600 is an example where the apparatus or the UE (e.g., UE 502) performs operations associated with signaling associated with beam activation and deactivation.

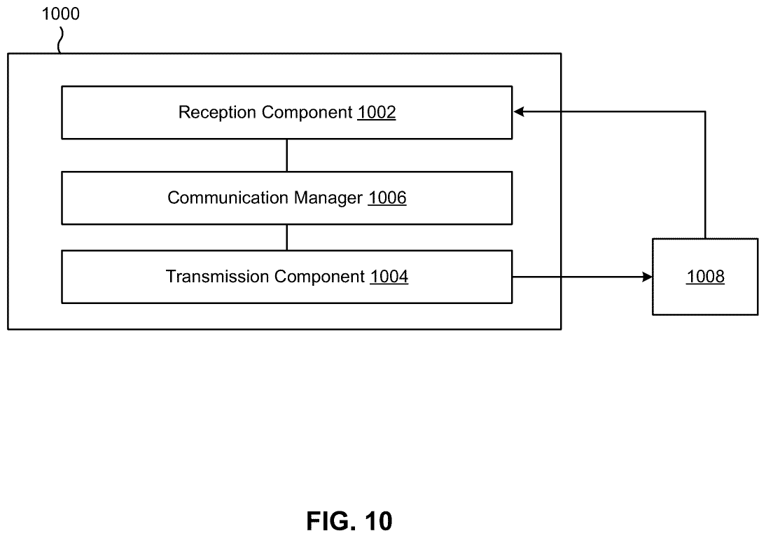

As shown in FIG. 6, in some aspects, process 600 may include receiving first system information indicative of a first SSB configuration, the first SSB configuration indicating a plurality of SSBs comprising at least one deactivated SSB (block 610). For example, the UE (e.g., using reception component 1002 and/or communication manager 1006, depicted in FIG. 10) may receive first system information indicative of a first SSB configuration, the first SSB configuration indicating a plurality of SSBs comprising at least one deactivated SSB, as described above.

As further shown in FIG. 6, in some aspects, process 600 may include receiving, based on a reactivation of the at least one deactivated SSB, second system information, the second system information omitting a second SSB configuration (block 620). For example, the UE (e.g., using reception component 1002 and/or communication manager 1006, depicted in FIG. 10) may receive, based on a reactivation of the at least one deactivated SSB, second system information, the second system information omitting a second SSB configuration, as described above.

Process 600 may include additional aspects, such as any single aspect or any combination of aspects described below and/or in connection with one or more other processes described elsewhere herein.

In a first aspect, the second system information indicates at least one of an updated SSB coverage state or an updated SSB activated list.

In a second aspect, alone or in combination with the first aspect, the first SSB configuration indicates a quantity of supported SSBs and a plurality of indexes, each index of the plurality of indexes corresponding to a respective SSB of the plurality of SSBs.

In a third aspect, alone or in combination with one or more of the first and second aspects, the plurality of SSBs are mapped to a plurality of respective beams.

In a fourth aspect, alone or in combination with one or more of the first through third aspects, the second system information indicates a difference between the first SSB configuration and the second SSB configuration.

In a fifth aspect, alone or in combination with one or more of the first through fourth aspects, the first SSB configuration comprises a first SSB bitmap or the second SSB configuration comprises a second SSB bitmap.

In a sixth aspect, alone or in combination with one or more of the first through fifth aspects, the first SSB bitmap is mapped to a plurality of indexes, or the second SSB bitmap is mapped to the plurality of indexes.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node, in accordance with the present disclosure. Example process 700 is an example where the apparatus or the network node (e.g., network node 504) performs operations associated with signaling associated with beam activation and deactivation.

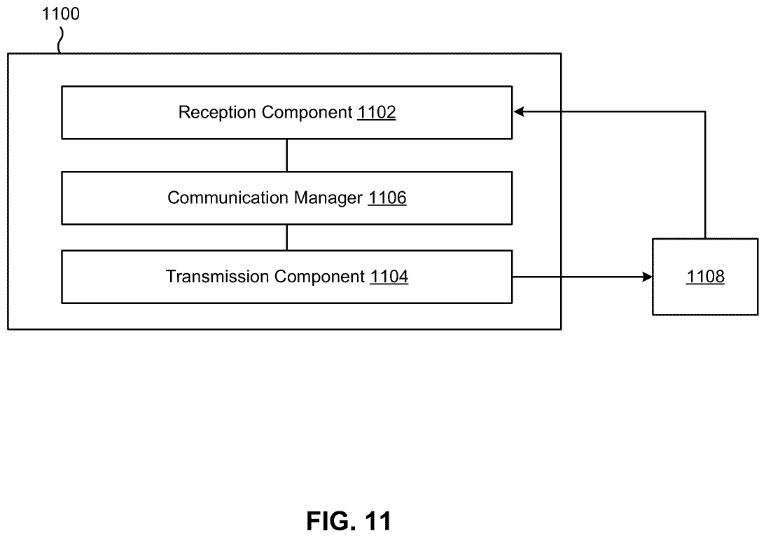

As shown in FIG. 7, in some aspects, process 700 may include transmitting first system information indicative of a first SSB configuration, the first SSB configuration indicating a plurality of SSBs comprising at least one deactivated SSB (block 710). For example, the network node (e.g., using transmission component 1104 and/or communication manager 1106, depicted in FIG. 11) may transmit first system information indicative of a first SSB configuration, the first SSB configuration indicating a plurality of SSBs comprising at least one deactivated SSB, as described above.

As further shown in FIG. 7, in some aspects, process 700 may include transmitting, based on a reactivation of the at least one deactivated SSB, second system information, the second system information omitting a second SSB configuration (block 720). For example, the network node (e.g., using transmission component 1104 and/or communication manager 1106, depicted in FIG. 11) may transmit, based on a reactivation of the at least one deactivated SSB, second system information, the second system information omitting a second SSB configuration, as described above.

Process 700 may include additional aspects, such as any single aspect or any combination of aspects described below and/or in connection with one or more other processes described elsewhere herein.

In a first aspect, the second system information indicates at least one of an updated SSB coverage state or an updated SSB activated list.

In a second aspect, alone or in combination with the first aspect, the first SSB configuration indicates a quantity of supported SSBs and a plurality of indexes, each index of the plurality of indexes corresponding to a respective SSB of the plurality of SSBs.

In a third aspect, alone or in combination with one or more of the first and second aspects, the plurality of SSBs are mapped to a plurality of respective beams.

In a fourth aspect, alone or in combination with one or more of the first through third aspects, the second system information indicates a difference between the first SSB configuration and the second SSB configuration.

In a fifth aspect, alone or in combination with one or more of the first through fourth aspects, the first SSB configuration comprises a first SSB bitmap or the second SSB configuration comprises a second SSB bitmap.

In a sixth aspect, alone or in combination with one or more of the first through fifth aspects, the first SSB bitmap is mapped to a plurality of indexes, or the second SSB bitmap is mapped to the plurality of indexes.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node, an apparatus of a network node, a UE, or an apparatus of a UE, in accordance with the present disclosure. Example process 800 is an example where the apparatus of the UE (e.g., UE 502), the UE, the apparatus of the network node (e.g., network node 504, DU 1202, CU 1204, or CU 1206) performs operations associated with signaling associated with beam activation and deactivation.

As shown in FIG. 8, in some aspects, process 800 may include receiving first information comprising first SSB coverage information associated with a first physical beam mapping (block 810). For example, the network node or the UE (e.g., using reception component 1002 and/or communication manager 1006, depicted in FIG. 10, or using reception component 1102 and/or communication manager 1106, depicted in FIG. 11) may receive first information comprising first SSB coverage information associated with a first physical beam mapping, as described above.

As further shown in FIG. 8, in some aspects, process 800 may include receiving, based on at least one of a reactivation of at least one deactivated SSB or a deactivation of at least one activated SSB, second information comprising second SSB coverage information associated with a second physical beam mapping (block 820). For example, the network node or the UE (e.g., using reception component 1002 and/or communication manager 1006, depicted in FIG. 10, or using reception component 1102 and/or communication manager 1106, depicted in FIG. 11) may receive, based on at least one of a reactivation of at least one deactivated SSB or a deactivation of at least one activated SSB, second information comprising second SSB coverage information associated with a second physical beam mapping, as described above.

Process 800 may include additional aspects, such as any single aspect or any combination of aspects described below and/or in connection with one or more other processes described elsewhere herein.

In a first aspect, the first physical beam mapping maps a first physical beam direction to a first SSB index and the second physical beam mapping maps a second physical beam direction to the first SSB index.

In a second aspect, alone or in combination with the first aspect, the first SSB coverage information indicates a first beam direction and the second SSB coverage information indicates a second beam direction.

In a third aspect, alone or in combination with one or more of the first and second aspects, the first SSB coverage information indicates a first beamforming codebook element and the second SSB coverage information indicates a second beamforming codebook element.

In a fourth aspect, alone or in combination with one or more of the first through third aspects, at least one of the first beamforming codebook element or the second beamforming codebook element indicates a physical beam direction and a beam shape.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 504, DU 1202, CU 1204, or CU 1206) performs operations associated with signaling associated with beam activation and deactivation.

As shown in FIG. 9, in some aspects, process 900 may include transmitting first information comprising first SSB coverage information associated with a first physical beam mapping (block 910). For example, the network node (e.g., using transmission component 1104 and/or communication manager 1106, depicted in FIG. 11) may transmit first information comprising first SSB coverage information associated with a first physical beam mapping, as described above.

As further shown in FIG. 9, in some aspects, process 900 may include transmitting, based on at least one of a reactivation of at least one deactivated SSB or a deactivation of at least one activated SSB, second information comprising second SSB coverage information associated with a second physical beam mapping (block 920). For example, the network node (e.g., using transmission component 1104 and/or communication manager 1106, depicted in FIG. 11) may transmit, based on at least one of a reactivation of at least one deactivated SSB or a deactivation of at least one activated SSB, second information comprising second SSB coverage information associated with a second physical beam mapping, as described above.

Process 900 may include additional aspects, such as any single aspect or any combination of aspects described below and/or in connection with one or more other processes described elsewhere herein.

In a first aspect, the first physical beam mapping maps a first physical beam direction to a first SSB index and the second physical beam mapping maps a second physical beam direction to the first SSB index.

In a second aspect, alone or in combination with the first aspect, the first SSB coverage information indicates a first beam direction and the second SSB coverage information indicates a second beam direction.

In a third aspect, alone or in combination with one or more of the first and second aspects, the first SSB coverage information indicates a first beamforming codebook element and the second SSB coverage information indicates a second beamforming codebook element.

In a fourth aspect, alone or in combination with one or more of the first through third aspects, at least one of the first beamforming codebook element or the second beamforming codebook element indicates a physical beam direction and a beam shape.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 5. Additionally, or alternatively, the apparatus 1000 may be configured to perform one or more processes described herein, such as process 600 of FIG. 6, process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1004 may be co-located with the reception component 1002 in one or more transceivers.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive first system information indicative of a first SSB configuration, the first SSB configuration indicating a plurality of SSBs comprising at least one deactivated SSB. The reception component 1002 may receive, based on a reactivation of the at least one deactivated SSB, second system information, the second system information omitting a second SSB configuration.

The reception component 1002 may receive first system information comprising first SSB coverage information associated with a first physical beam mapping. The reception component 1002 may receive, based on at least one of a reactivation of at least one deactivated SSB or a deactivation of at least one activated SSB, second system information comprising second SSB coverage information associated with a second physical beam mapping.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIG. 5. Additionally, or alternatively, the apparatus 1100 may be configured to perform one or more processes described herein, such as process 700 of FIG. 7, process 900 of FIG. 9, or a combination thereof. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit first system information indicative of a first SSB configuration, the first SSB configuration indicating a plurality of SSBs comprising at least one deactivated SSB. The transmission component 1104 may transmit, based on a reactivation of the at least one deactivated SSB, second system information, the second system information omitting a second SSB configuration.

The transmission component 1104 may transmit first system information comprising first SSB coverage information associated with a first physical beam mapping. The transmission component 1104 may transmit, based on at least one of a reactivation of at least one deactivated SSB or a deactivation of at least one activated SSB, second system information comprising second SSB coverage information associated with a second physical beam mapping.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram illustrating an example 1200 of signaling of SSB coverage information associated with physical beam mappings, in accordance with the present disclosure. Example 1200 includes two or more of a DU 1202 (e.g., network node 110, DU 330, network node 504), a CU 1204 (e.g., network node 110, CU 310, network node 504), or a CU 1206 (e.g., network node 110, CU 310, network node 504). The signaling of example 1200 may be performed on a backhaul connection associated with a backhaul interface, such as an Xn interface or an F1 interface.

Various actions and signaling are described in connection with FIG. 12 as occurring at various times (T0, T1, T2, and so on). It should be noted that not all of these actions may occur, and actions that do occur may not occur in the order indicated by T0, T1, T2, and so on.

As shown, in some aspects, the DU 1202 may transmit, and the CU 1204 may receive, an F1 setup request 1208. In some examples, the F1 setup request 1208 may indicate one or more of SSB positions in a burst or coverage state information associated with one or more directions. For example, the F1 setup request 1208 may indicate one or more of SSB positions in a burst or SSB coverage state information (e.g., SSB coverage information) associated with a physical beam mapping.

As shown, in some aspects, the CU 1204 may transmit, and the CU 1206 may receive, an Xn setup request and/or response 1210. In some examples, the Xn setup request and/or response 1210 may indicate one or more of SSB positions in a burst or coverage state information associated with one or more directions. For example, the Xn setup request and/or response 1210 may indicate one or more of SSB positions in a burst or SSB coverage state information associated with a physical beam mapping.

As shown, in some aspects, the DU 1202 may transmit, and the CU 1204 may receive, a gNB-DU configuration update 1212. In some examples, the gNB-DU configuration update 1212 may indicate one or more of updated SSB positions in a burst or updated coverage state information associated with one or more directions. This may be in connection with modifying SSBs and/or beams of the DU 1202, as indicated by reference number 1220. In some examples, the gNB-DU configuration update 1212 may indicate one or more of SSB positions in a burst or updated SSB coverage state information associated with a physical beam mapping.

As shown, in some aspects, the CU 1204 may transmit, and the CU 1206 may receive, an NG-RAN node configuration update 1214. In some examples, the NG-RAN node configuration update 1214 may indicate one or more of updated SSB positions in a burst or updated coverage state information associated with one or more directions. This may be in connection with modifying SSBs and/or beams of the DU 1202, as indicated by reference number 1220. In some examples, the NG-RAN node configuration update 1214 may indicate one or more of SSB positions in a burst or updated SSB coverage state information associated with a physical beam mapping.

As shown, in some aspects, the CU 1206 may transmit, and the CU 1204 may receive, a cell activation request 1216. In some examples, the cell activation request 1216 may indicate one or more of an SSBs to be activated list or a coverage state to be activated or modified list. This may be in connection with the CU 1206 requesting a modification to the DU 1202's SSBs and/or beams, as indicated by reference number 1222. In some examples, the cell activation request 1216 may indicate one or more of SSB positions in a burst or updated SSB coverage state information associated with a physical beam mapping, such as a coverage state to be activated or modified.

As shown, in some aspects, the CU 1204 may transmit, and the DU 1202 may receive, a gNB-CU configuration update 1218. In some examples, the gNB-CU configuration update 1218 may include one or more of an SSBs to be activated list or a coverage state to be activated or modified list. This may be in connection with the CU 1206 requesting a modification to the DU 1202's SSBs and/or beams, as indicated by reference number 1222. In some examples, the gNB-CU configuration update 1218 may indicate one or more of SSB positions in a burst or updated SSB coverage state information associated with a physical beam mapping, such as a coverage state to be activated or modified list, a coverage state to be removed list, an SSB to be activated list, or an SSB to be removed list.

In some aspects, as mentioned, the F1 setup request 1208 or the Xn setup request and/or response 1210 may include SSB coverage information associated with a physical beam mapping. For example, at a time T0, the F1 setup request 1208 or the Xn setup request and/or response 1210 may indicate that the DU 1202 supports 10 SSBs associated with physical beam mappings (that is, directions) d0 through d9:
SSB Positions In Burst=11111111110 . . . 0
SSB coverage information: SSB List:
   Item 0: SSB index=0, SSB Coverage State (physical beam mapping)=d0.
   . . .
   Item 9: SSB index=9, SSB Coverage State (physical beam mapping)=d9.

In some aspects, as mentioned in connection with reference number 1220, the DU 1202 may modify SSBs and/or beams of the DU 1202. For example, in some aspects, at a time T1, the DU 1202 may deactivate a first SSB. In this example, the DU may modify an indication of SSB positions in a burst: [modified] SSB Positions In Burst=01111111110 . . . 0, which may be suitable for semi-permanent deactivation of the first SSB. Alternatively, the DU 1202 may provide an indication of a modified physical beam mapping in gNB-DU configuration update 1212 (which may be forwarded in NG-RAN node configuration update 1214):
SSB Positions In Burst=11111111110 . . . 0
SSB List:
   [modified] Item 0: SSB index=0, SSB Coverage State=0.

In some aspects, as mentioned in connection with reference number 1220, the DU 1202 may modify SSBs and/or beams of the DU 1202. For example, in some aspects, at a time T2, the DU 1202 may change a direction of the first SSB to do′. In this example, the DU 1202 may provide an indication of a modified physical beam mapping in gNB-DU configuration update 1212 (which may be forwarded in NG-RAN node configuration update 1214):
SSB Positions In Burst=11111111110 . . . 0
SSB List:
   [modified] Item 0: SSB index=0, SSB Coverage State=d0′.

In some aspects, as mentioned in connection with reference number 1222, the CU 1206 (or the CU 1204) may request a modification to the DU 1202's SSBs and/or beams. For example, in some aspects, the CU 1204 or 1206 may request for the DU 1202 to reactivate a previously deactivated SSB transmission in direction do. In this example, the CU 1204 or 1206 may provide updated SSB coverage information associated with a physical beam mapping, such as a coverage state to be activated or modified, in the cell activation request 1216 (which may be forwarded in the gNB-CU configuration update 1218):
Coverage State to be Activated/Modified List:
   [modified] Item 0: SSB Coverage State=d0

In some aspects, as mentioned in connection with reference number 1222, the CU 1206 (or the CU 1204) may request a modification to the DU 1202's SSBs and/or beams. For example, in some aspects, the CU 1204 or 1206 may request for the DU 1202 to rearrange a beam sweep configuration to swap directions associated with SSB8 and SSB9. In this example, the CU 1204 or 1206 may provide updated SSB coverage information associated with a physical beam mapping, such as a coverage state to be activated or modified, in the cell activation request 1216 (which may be forwarded in the gNB-CU configuration update 1218):
Coverage State to be Activated/Modified List:
   [modified] Item 0: SSB Coverage State=d9, SSB index=8
   [modified] Item 1: SSB Coverage State=d8, SSB index=9

In some aspects, as mentioned in connection with reference number 1222, the CU 1206 (or the CU 1204) may request a modification to the DU 1202's SSBs and/or beams. For example, in some aspects, the CU 1204 or 1206 may request for the DU 1202 to deactivate a direction dx. In this example, the CU 1204 or 1206 may provide updated SSB coverage information associated with a physical beam mapping, such as a coverage state to be activated or modified, in the cell activation request 1216 (which may be forwarded in the gNB-CU configuration update 1218):
Coverage State to be Removed List:
   Item 0: SSB Coverage State=dx

In some aspects, as mentioned in connection with reference number 1222, the CU 1206 (or the CU 1204) may request a modification to the DU 1202's SSBs and/or beams. For example, in some aspects, the CU 1204 or 1206 may request for the DU 1202 to skip transmission on an SSB index i. In this example, the CU 1204 or 1206 may provide updated SSB coverage information associated with a physical beam mapping, such as a coverage state to be activated or modified, in the cell activation request 1216 (which may be forwarded in the gNB-CU configuration update 1218):
SSBs to be Removed List:
   Item 0: SSB index=i

In some aspects, first information (such as the F1 setup request 1208 or the Xn setup request and/or response 1210) may include first SSB coverage information and the second information (such as in gNB-DU configuration update 1212, NG-RAN node configuration update 1214, cell activation request 1216, or gNB-CU configuration update 1218) may include second SSB coverage information. The first SSB coverage information may be associated with a first physical beam mapping and the second SSB coverage information may be associated with a second physical beam mapping. The first physical beam mapping may map a first physical beam direction to a first SSB index and the second physical beam mapping may map a second physical beam direction to the first SSB index.

In some aspects, a network node such as DU 1202, CU 1204, or CU 1206 may rearrange the SSB index mappings to facilitate reduction of time gaps in a resulting burst. For example, in accordance with a first physical beam mapping, an SSB burst may be configured such that SSB1 is transmitted in a first SSB occasion, SSB2 is transmitted in a second SSB occasion, SSB3 is transmitted in a third SSB occasion, SSB4 is transmitted in a fourth SSB occasion, SSB5 is transmitted in a fifth SSB occasion, SSB6 is transmitted in a sixth SSB occasion, SSB7 is transmitted in a seventh SSB occasion, and SSB8 is transmitted in an eighth SSB occasion. The network node may rearrange the physical beam mappings to create a second physical beam mapping, in which SSB1-SSB3 are mapped to D1-D3, respectively, and SSB4 and SSB5 are mapped to direction D7 and D8, respectively. In this way, the network node may transmit an SSB burst in which there is no time gap between any adjacent pair of swept SSBs.

In some aspects, the first SSB coverage information may indicate a first beam direction and the second SSB coverage information may indicate a second beam direction. In some aspects, the first SSB coverage information may indicate a first beamforming codebook element and the second SSB coverage information may indicate a second beamforming codebook element. For example, at least one of the first beamforming codebook element or the second beamforming codebook element may indicate a physical beam direction and a beam shape. A beamforming codebook element may be referred to as a direction (e.g., d1 above).

As indicated above, FIG. 12 is provided as an example. Other examples may differ from what is described with regard to FIG. 12.

The following provides an overview of some Aspects of the present disclosure:
Aspect 1: A method of wireless communication performed by a user equipment (UE), comprising: receiving first system information indicative of a first synchronization signal block (SSB) configuration, the first SSB configuration indicating a plurality of SSBs comprising at least one deactivated SSB; and receiving, based on a reactivation of the at least one deactivated SSB, second system information, the second system information omitting a second SSB configuration.
Aspect 2: The method of Aspect 1, wherein the second system information indicates at least one of an updated SSB coverage state or an updated SSB activated list.
Aspect 3: The method of either of Aspects 1 or 2, wherein the first SSB configuration indicates a quantity of supported SSBs and a plurality of indexes, each index of the plurality of indexes corresponding to a respective SSB of the plurality of SSBs.
Aspect 4: The method of any of Aspects 1-3, wherein the plurality of SSBs are mapped to a plurality of respective beams.
Aspect 5: The method of any of Aspects 1-4, wherein the second system information indicates a difference between the first SSB configuration and the second SSB configuration.
Aspect 6: The method of any of Aspects 1-5, wherein the first SSB configuration comprises a first SSB bitmap or the second SSB configuration comprises a second SSB bitmap.
Aspect 7: The method of Aspect 6, wherein the first SSB bitmap is mapped to a plurality of indexes, or wherein the second SSB bitmap is mapped to the plurality of indexes.
Aspect 8: A method of wireless communication performed by a network node, comprising: transmitting first system information indicative of a first synchronization signal block (SSB) configuration, the first SSB configuration indicating a plurality of SSBs comprising at least one deactivated SSB; and transmitting, based on a reactivation of the at least one deactivated SSB, second system information, the second system information omitting a second SSB configuration.
Aspect 9: The method of Aspect 8, wherein the second system information indicates at least one of an updated SSB coverage state or an updated SSB activated list.
Aspect 10: The method of either of Aspects 8 or 9, wherein the first SSB configuration indicates a quantity of supported SSBs and a plurality of indexes, each index of the plurality of indexes corresponding to a respective SSB of the plurality of SSBs.
Aspect 11: The method of any of Aspects 8-10, wherein the plurality of SSBs are mapped to a plurality of respective beams.
Aspect 12: The method of any of Aspects 8-11, wherein the second system information indicates a difference between the first SSB configuration and the second SSB configuration.
Aspect 13: The method of any of Aspects 8-12, wherein the first SSB configuration comprises a first SSB bitmap or the second SSB configuration comprises a second SSB bitmap.
Aspect 14: The method of Aspect 13, wherein the first SSB bitmap is mapped to a plurality of indexes, or wherein the second SSB bitmap is mapped to the plurality of indexes.
Aspect 15: A method of wireless communication performed by a network node, comprising: receiving first information comprising first synchronization signal block (SSB) coverage information associated with a first physical beam mapping; and receiving, based on at least one of a reactivation of at least one deactivated SSB or a deactivation of at least one activated SSB, second information comprising second SSB coverage information associated with a second physical beam mapping.
Aspect 16: The method of Aspect 15, wherein the first physical beam mapping maps a first physical beam direction to a first SSB index and the second physical beam mapping maps a second physical beam direction to the first SSB index.
Aspect 17: The method of either of Aspects 15 or 16, wherein the first SSB coverage information indicates a first beam direction and wherein the second SSB coverage information indicates a second beam direction.
Aspect 18: The method of any of Aspects 15-17, wherein the first SSB coverage information indicates a first beamforming codebook element and wherein the second SSB coverage information indicates a second beamforming codebook element.
Aspect 19: The method of Aspect 18, wherein at least one of the first beamforming codebook element or the second beamforming codebook element indicates a physical beam direction and a beam shape.
Aspect 20: A method of wireless communication performed by a network node, comprising: transmitting first system information comprising first synchronization signal block (SSB) coverage information associated with a first physical beam mapping; and transmitting, based on at least one of a reactivation of at least one deactivated SSB or a deactivation of at least one activated SSB, second system information comprising second SSB coverage information associated with a second physical beam mapping.
Aspect 21: The method of Aspect 20, wherein the first physical beam mapping maps a first physical beam direction to a first SSB index and the second physical beam mapping maps a second physical beam direction to the first SSB index.
Aspect 22: The method of either of Aspects 20 or 21, wherein the first SSB coverage information indicates a first beam direction and wherein the second SSB coverage information indicates a second beam direction.
Aspect 23: The method of any of Aspects 20-22, wherein the first SSB coverage information indicates a first beamforming codebook element and wherein the second SSB coverage information indicates a second beamforming codebook element.
Aspect 24: The method of Aspect 23, wherein at least one of the first beamforming codebook element or the second beamforming codebook element indicates a physical beam direction and a beam shape.
Aspect 25: An apparatus for wireless communication at a device, wherein the device may be a UE, the apparatus comprising one or more processors; one or more memories coupled with the one or more processors; and instructions stored in the one or more memories and executable by the one or more processors to cause the apparatus to perform the method of one or more of Aspects 1-7.
Aspect 26: An apparatus for wireless communication at a device, wherein the device may be a UE, the apparatus comprising one or more memories and one or more processors coupled to the one or more memories, the one or more processors configured to cause the device to perform the method of one or more of Aspects 1-7.
Aspect 27: An apparatus for wireless communication, the apparatus comprising at least one means for performing the method of one or more of Aspects 1-7.
Aspect 28: A non-transitory computer-readable medium storing code for wireless communication, the code comprising instructions executable by one or more processors to perform the method of one or more of Aspects 1-7.
Aspect 29: A non-transitory computer-readable medium storing a set of instructions for wireless communication, the set of instructions comprising one or more instructions that, when executed by one or more processors of a device, cause the device to perform the method of one or more of Aspects 1-7, wherein the device may be a UE.
Aspect 30: A device for wireless communication, the device comprising a processing system that includes one or more processors and one or more memories coupled with the one or more processors, the processing system configured to cause the device to perform the method of one or more of Aspects 1-7, wherein the device may be a UE.
Aspect 31: An apparatus for wireless communication at a device, wherein the device may be a UE, the apparatus comprising one or more memories and one or more processors coupled to the one or more memories, the one or more processors individually or collectively configured to cause the device to perform the method of one or more of Aspects 1-7.
Aspect 32: An apparatus for wireless communication at a device, wherein the device may be a network node, the apparatus comprising one or more processors; one or more memories coupled with the one or more processors; and instructions stored in the one or more memories and executable by the one or more processors to cause the apparatus to perform the method of one or more of Aspects 8-14.
Aspect 33: An apparatus for wireless communication at a device, wherein the device may be a network node, the apparatus comprising one or more memories and one or more processors coupled to the one or more memories, the one or more processors configured to cause the device to perform the method of one or more of Aspects 8-14.
Aspect 34: An apparatus for wireless communication, the apparatus comprising at least one means for performing the method of one or more of Aspects 8-14.
Aspect 35: A non-transitory computer-readable medium storing code for wireless communication, the code comprising instructions executable by one or more processors to perform the method of one or more of Aspects 8-14.
Aspect 36: A non-transitory computer-readable medium storing a set of instructions for wireless communication, the set of instructions comprising one or more instructions that, when executed by one or more processors of a device, cause the device to perform the method of one or more of Aspects 8-14, wherein the device may be a network node.
Aspect 37: A device for wireless communication, wherein the device may be a network node, the device comprising a processing system that includes one or more processors and one or more memories coupled with the one or more processors, the processing system configured to cause the device to perform the method of one or more of Aspects 8-14.
Aspect 38: An apparatus for wireless communication at a device, wherein the device may be a network node, the apparatus comprising one or more memories and one or more processors coupled to the one or more memories, the one or more processors individually or collectively configured to cause the device to perform the method of one or more of Aspects 8-14.
Aspect 39: An apparatus for wireless communication at a device, wherein the device may be a network node, the apparatus comprising one or more processors; one or more memories coupled with the one or more processors; and instructions stored in the one or more memories and executable by the one or more processors to cause the apparatus to perform the method of one or more of Aspects 15-19.
Aspect 40: An apparatus for wireless communication at a device, wherein the device may be a network node, the apparatus comprising one or more memories and one or more processors coupled to the one or more memories, the one or more processors configured to cause the device to perform the method of one or more of Aspects 15-19.
Aspect 41: An apparatus for wireless communication, the apparatus comprising at least one means for performing the method of one or more of Aspects 15-19.
Aspect 42: A non-transitory computer-readable medium storing code for wireless communication, the code comprising instructions executable by one or more processors to perform the method of one or more of Aspects 15-19.
Aspect 43: A non-transitory computer-readable medium storing a set of instructions for wireless communication, the set of instructions comprising one or more instructions that, when executed by one or more processors of a device, cause the device to perform the method of one or more of Aspects 15-19, wherein the device may be a network node.
Aspect 44: A device for wireless communication, wherein the device may be a network node, the device comprising a processing system that includes one or more processors and one or more memories coupled with the one or more processors, the processing system configured to cause the device to perform the method of one or more of Aspects 15-19.
Aspect 45: An apparatus for wireless communication at a device, wherein the device may be a network node, the apparatus comprising one or more memories and one or more processors coupled to the one or more memories, the one or more processors individually or collectively configured to cause the device to perform the method of one or more of Aspects 15-19.
Aspect 46: An apparatus for wireless communication at a device, wherein the device may be a network node, the apparatus comprising one or more processors; one or more memories coupled with the one or more processors; and instructions stored in the one or more memories and executable by the one or more processors to cause the apparatus to perform the method of one or more of Aspects 20-24.
Aspect 47: An apparatus for wireless communication at a device, wherein the device may be a network node, the apparatus comprising one or more memories and one or more processors coupled to the one or more memories, the one or more processors configured to cause the device to perform the method of one or more of Aspects 20-24.
Aspect 48: An apparatus for wireless communication, the apparatus comprising at least one means for performing the method of one or more of Aspects 20-24.
Aspect 49: A non-transitory computer-readable medium storing code for wireless communication, the code comprising instructions executable by one or more processors to perform the method of one or more of Aspects 20-24.
Aspect 50: A non-transitory computer-readable medium storing a set of instructions for wireless communication, the set of instructions comprising one or more instructions that, when executed by one or more processors of a device, cause the device to perform the method of one or more of Aspects 20-24, wherein the device may be a network node.
Aspect 51: A device for wireless communication, wherein the device may be a network node, the device comprising a processing system that includes one or more processors and one or more memories coupled with the one or more processors, the processing system configured to cause the device to perform the method of one or more of Aspects 20-24.
Aspect 52: An apparatus for wireless communication at a device, wherein the device may be a network node, the apparatus comprising one or more memories and one or more processors coupled to the one or more memories, the one or more processors individually or collectively configured to cause the device to perform the method of one or more of Aspects 20-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node for wireless communication, comprising:
one or more memories; and
one or more processors, coupled to the one or more memories, which are configured, individually or in any combination, to cause the network node to:
transmit first synchronization signal block (SSB) coverage information associated with a first physical beam mapping; and
transmit, based on at least one of a reactivation of at least one deactivated SSB or a deactivation of at least one activated SSB, second SSB coverage information associated with a second physical beam mapping.

2. The network node of claim 1, wherein the first physical beam mapping maps a first physical beam direction to a first SSB index and the second physical beam mapping maps a second physical beam direction to the first SSB index.

3. The network node of claim 1, wherein the first SSB coverage information indicates a first beam direction and wherein the second SSB coverage information indicates a second beam direction.

4. The network node of claim 1, wherein the first SSB coverage information indicates a first beamforming codebook element and wherein the second SSB coverage information indicates a second beamforming codebook element.

5. The network node of claim 4, wherein at least one of the first beamforming codebook element or the second beamforming codebook element indicates a physical beam direction and a beam shape.

6. The network node of claim 1, wherein the one or more processors, to cause the network node to transmit the second SSB coverage information, are configured to cause the network node to transmit the second SSB coverage information via a backhaul interface.

7. A network node for wireless communication, comprising:
one or more memories; and
one or more processors, coupled to the one or more memories, which are configured, individually or in any combination, to cause the network node to:
receive first synchronization signal block (SSB) coverage information associated with a first physical beam mapping; and
receive, based on at least one of a reactivation of at least one deactivated SSB or a deactivation of at least one activated SSB, second SSB coverage information associated with a second physical beam mapping.

8. The network node of claim 7, wherein the first physical beam mapping maps a first physical beam direction to a first SSB index and the second physical beam mapping maps a second physical beam direction to the first SSB index.

9. The network node of claim 7, wherein the first SSB coverage information indicates a first beam direction and wherein the second SSB coverage information indicates a second beam direction.

10. The network node of claim 7, wherein the first SSB coverage information indicates a first beamforming codebook element and wherein the second SSB coverage information indicates a second beamforming codebook element.

11. The network node of claim 10, wherein at least one of the first beamforming codebook element or the second beamforming codebook element indicates a physical beam direction and a beam shape.

12. The network node of claim 10, wherein the one or more processors, to cause the network node to receive the second SSB coverage information, are configured to cause the network node to receive the second SSB coverage information via a backhaul interface.

13. A user equipment (UE) for wireless communication, comprising:
one or more memories; and
one or more processors, coupled to the one or more memories, wherein the one or more processors are configured, individually or in any combination, to cause the UE to:
receive first system information indicative of a first synchronization signal block (SSB) configuration, the first SSB configuration indicating a plurality of SSBs comprising at least one deactivated SSB; and
receive, based on a reactivation of the at least one deactivated SSB, second system information, the second system information omitting a second SSB configuration.

14. The UE of claim 13, wherein the second system information indicates at least one of an updated SSB coverage state or an updated SSB activated list.

15. The UE of claim 13, wherein the first SSB configuration indicates a quantity of supported SSBs and a plurality of indexes, each index of the plurality of indexes corresponding to a respective SSB of the plurality of SSBs.

16. The UE of claim 13, wherein the plurality of SSBs are mapped to a plurality of respective beams.

17. The UE of claim 13, wherein the second system information indicates a difference between the first SSB configuration and the second SSB configuration.

18. The UE of claim 13, wherein the first SSB configuration comprises a first SSB bitmap or the second SSB configuration comprises a second SSB bitmap.

19. The UE of claim 18, wherein the first SSB bitmap is mapped to a plurality of indexes, or wherein the second SSB bitmap is mapped to the plurality of indexes.

20. A network node for wireless communication, comprising:
one or more memories; and
one or more processors, coupled to the one or more memories, which are configured, individually or in any combination, to cause the network node to:
transmit first system information indicative of a first synchronization signal block (SSB) configuration, the first SSB configuration indicating a plurality of SSBs comprising at least one deactivated SSB; and
transmit, based on a reactivation of the at least one deactivated SSB, second system information, the second system information omitting a second SSB configuration.

21. The network node of claim 20, wherein the second system information indicates at least one of an updated SSB coverage state or an updated SSB activated list.

22. The network node of claim 20, wherein the first SSB configuration indicates a quantity of supported SSBs and a plurality of indexes, each index of the plurality of indexes corresponding to a respective SSB of the plurality of SSBs.

23. The network node of claim 20, wherein the plurality of SSBs are mapped to a plurality of respective beams.

24. The network node of claim 20, wherein the second system information indicates a difference between the first SSB configuration and the second SSB configuration.

25. The network node of claim 20, wherein the first SSB configuration comprises a first SSB bitmap or the second SSB configuration comprises a second SSB bitmap.

26. The network node of claim 25, wherein the first SSB bitmap is mapped to a plurality of indexes, or wherein the second SSB bitmap is mapped to the plurality of indexes.
